(19) United States
(12) Patent Application Publication
(10) Pub. No.: US 2024/0394044 A1
(43) Pub. Date: Nov. 28, 2024

(54) CONTROL DEVICE, CONTROL SYSTEM, CONTROL METHOD, AND CONTROL PROGRAM

(71) Applicant: Yazaki Corporation, Tokyo (JP)

(72) Inventor: Jun GOTO, Makinohara-shi (JP)

(73) Assignee: Yazaki Corporation, Tokyo (JP)

(21) Appl. No.: 18/653,102

(22) Filed: May 2, 2024

(30) Foreign Application Priority Data
May 22, 2023 (JP) 2023-083707

(51) Int. Cl. G06F 8/656

(52) U.S. Cl. CPC G06F 8/656

(57) ABSTRACT

A second control device includes a storage unit and a control unit, and connected to a first control device via a first communication network. The control unit includes an update processing unit configured to update software of the first control device, and a software acquisition processing unit configured to acquire the software of the first control device from the first control device before the update of the software of the first control device starts, and store the acquired software to the storage unit.

### TECHNICAL FIELD

The present invention relates to a control device, a control system, a control method, and a control program.

### BACKGROUND

As a method for updating the software of an electronic control unit (ECU) that controls electrical components of a vehicle, there is a method using wireless communication (over-the-air (OTA) update). For example, Patent Document 1 discloses a method of updating software of an ECU using OTA update in a zone-based control system.

### RELATED ART

### Patent Document

Patent Document 1: JP2022-160927 A

### SUMMARY OF THE INVENTION

### Problem to be Solved by the Invention

There are two types of software updates: a single bank configuration and a dual bank configuration, with single bank configuration being lower cost. However, when an ECU is updated with the single bank configuration, the unupdated (current version) ECU software cannot be preserved in the ECU during the ECU software update, and when the ECU software update fails, the ECU software cannot be restored. Furthermore, if the ECU is updated in the single bank configuration, the ECU functions cannot be executed while the ECU software is being updated.

Accordingly, it is an object of the present invention to update software of a control device at a low cost.

### Solution to Problem

In order to solve the above problem, a control device according to an embodiment of the present invention includes a storage unit and a control unit, and connected to a first control device via a first communication network, the control unit includes an update processing unit configured to update software of the first control device, and a software acquisition processing unit configured to acquire the software of the first control device from the first control device before the update of the software of the first control device starts, and store the acquired software to the storage unit.

The control system according to an embodiment of the present invention includes a plurality of first control devices, and a second control device as set forth above connected to the plurality of first control devices via the first communication network.

The control system according to an embodiment of the present invention includes a plurality of second control devices as set forth above and a third control device connected to the plurality of second control devices via a second communication network.

A control method according to an embodiment of the present invention is a control method executed by a second control device connected to a first control device via a first communication network, the control method including an update processing step of updating software of the first control device, and a software acquisition processing step of acquiring software of the first control device from the first control device before the update of the software of the first control device starts, and storing the acquired software to the storage unit of the second control device.

A control program according to an embodiment of the present invention causes a computer to execute the above-described control method.

### Advantageous Effects of the Invention

According to the present invention, software of a control device can be updated at a low cost.

### BRIEF DESCRIPTION OF THE DRAWINGS

FIG. 1 is a diagram illustrating a control system according to an embodiment of the present invention.

FIG. 2 is a diagram illustrating a first control device 100.

FIG. 3 is a diagram illustrating a second control device 200.

FIG. 4 is a diagram illustrating a control unit 210 of the second control device 200.

FIG. 5 is a diagram illustrating an example of a processing operation executed in the control unit 210 of the second control device 200 when another device has update data for the software of the first control device 100.

### DETAILED DESCRIPTION OF THE EXEMPLARY EMBODIMENT

### <Control System>

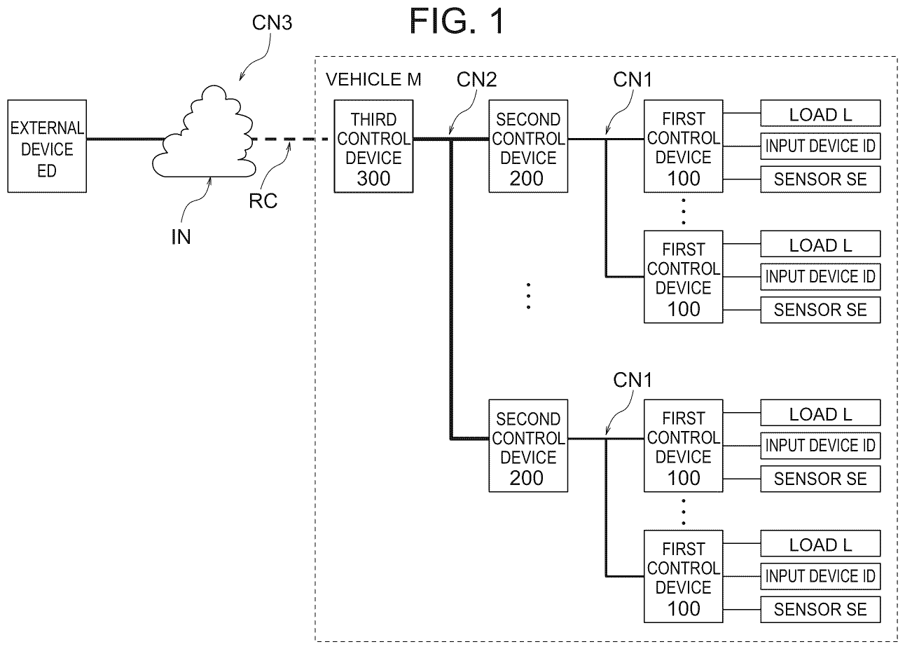

FIG. 1 is a diagram illustrating a control system according to an embodiment of the present invention. The control system according to the present embodiment includes first control devices 100, second control devices 200, and a third control device 300. The control system according to the present embodiment is, for example, a zone-based control system of a vehicle M. In this case, as illustrated in FIG. 1, the first control devices 100, the second control devices 200, and the third control device 300 are installed in the vehicle M.

The first control device 100 is connected to devices such as a load L, an input device ID (for example, switches), and a sensor SE. The first control device 100 outputs information (for example, control signals for the load L) to a device connected to the first control device 100. In addition, the first control device 100 receives input of information (for example, information received by the input device ID or a sensor signal of the sensor SE) from a device connected to the first control device 100.

In a case where the control system is a zone-based control system for the vehicle M, the load L is the electrical components of the vehicle M, for example, a vehicle's motor, a heater, and lightings. In this case, for example, in a case where the load L is a motor, the first control device 100 is an ECU for controlling the motor; in a case where the load L is a heater, the first control device 100 is an ECU for controlling the heater; and in a case where the load L is a lighting, the first control device 100 is an ECU for controlling the lighting.

The second control device 200 is connected to one or more first control devices 100 via a first communication network CN1, and the second control device 200 and the first control devices 100 connected to the second control device 200 communicate using the first communication network CN1. For example, the second control device 200 uses the first communication network CN1 to transmit information (for example, information for controlling the first control device 100 and the load L connected to the first control device 100) to the first control device 100 connected to the second control device 200. In addition, for example, the second control device 200 uses the first communication network CN1 to receive information (for example, information stored in the first control device 100 or information received by the first control device 100) from the first control device 100 connected to the second control device 200.

In a case where the control system is a zone-based control system for the vehicle M, the second control device 200 is a zone ECU. In the zone-based control system, the vehicle M is divided into multiple areas, and one zone ECU is provided in each of the multiple areas. In each of the multiple areas, the zone ECU manages the ECU for controlling the load L provided in that area. In this case, the communication standard of the first communication network CN1 is, for example, Ethernet (registered trademark), controller area network (CAN), Media-Oriented System Transport (Most), and FlexRay. In a case where the second control device 200 is a zone ECU, devices such as the load L, the input device ID, the sensor SE, and the like may be connected to the second control device 200.

The third control device 300 is connected to multiple second control devices 200 via a second communication network CN2 different from the first communication network CN1, and the third control device 300 and the second control devices 200 communicate using the second communication network CN2. The third control device 300 uses, for example, the second communication network CN2 to transmit information (for example, information for controlling the second control device 200, the first control device 100, and the load L connected to the first control device 100; and data for updating the software of the second control device 200 and the software of the first control device 100) to the second control device 200. In addition, for example, the third control device 300 uses the second communication network CN2 receives information (for example, information stored in the second control device 200 and the first control device 100; and information which the second control device 200 receives from the first control device 100) from the second control device 200.

In a case where the control system is a zone-based control system for the vehicle M, the third control device 300 is a central ECU. In this case, the communication standard of the second communication network CN2 is, for example, Ethernet (registered trademark).

The third control device 300 is connected to the external device ED via a third communication network CN3 that is different from the first communication network CN1 and the second communication network CN2, and the third control device 300 and the external device ED communicate using the third communication network CN3.

In a case where the control system is a zone-based control system for the vehicle M, the external device ED is provided outside the vehicle M. In this case, for example, the third communication network CN3 is a communication network including a radio communication RC (for example, cellular communication network and near-field radio communication (for example, Wi-Fi (registered trademark) and Bluetooth (registered trademark)) and the Internet IN, and for example, the third control device 300 is connected to the Internet IN via a radio communication RC.

### <First Control Device 100>

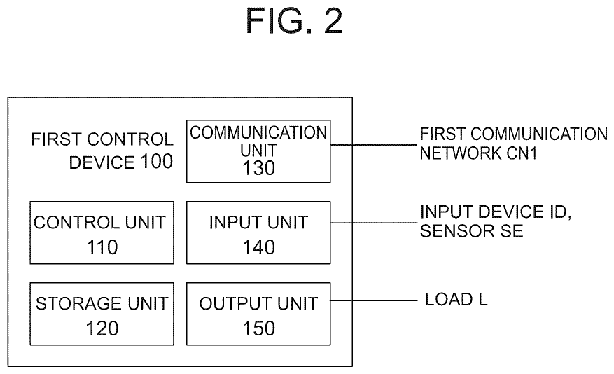

FIG. 2 is a diagram illustrating the first control device 100. The first control device 100 controls the load L connected to the first control device 100. The first control device 100 includes a control unit 110, a storage unit 120, a communication unit 130, an input unit 140, and an output unit 150.

The control unit 110 is an information processing device constituted by a computer. The storage unit 120 is a storage device for storing information such as memory. The communication unit 130 is a communication device for transmitting information to and receiving information from the second control device 200 via the first communication network CN1. The input unit 140 is a device for receiving input of information from the input device ID and the sensor SE. The output unit 150 is a device for outputting information to the load L.

The control unit 110 controls the load L connected to the first control device 100. For example, the control unit 110 outputs information based on information received using communication performed by the communication unit 130 (for example, information transmitted from another first control device, the second control device 200, the third control device 300, and the external device) and information that is received by the input unit 140 (for example, information from the input device ID and the sensor SE connected to the input unit 140) from the output unit 150 to the load L to control the load L.

The control unit 110 uses communication performed by the communication unit 130 to transmit information received by the input unit 140 (for example, information from the input device ID and the sensor SE connected to the input unit 140) to another device (another first control device 100, the second control device 200, the third control device 300, and the external device ED).

The storage unit 120 stores software (software of the first control device 100) for the control unit 110 to execute the functions of the first control device 100 including the above control.

In addition, the storage unit 120 stores not only the software of the first control device 100 but also software (substitution software) that cooperates with the second control device 200 and causes the second control device 200 to perform the functions of the first control device 100 on behalf of the second control device 200, which will be described later. The control unit 110 uses this substitution software to disable the software of the first control device 100 stored in the storage unit 120 while the functions of the first control device 100 are substituted by the second control device 200, which will be described later.

### <Second Control Device 200>

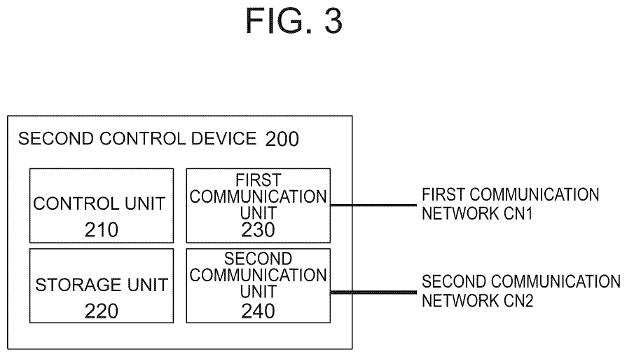

FIG. 3 is a diagram illustrating the second control device 200. The second control device 200 includes a control unit 210, a storage unit 220, a first communication unit 230, and a second communication unit 240.

The control unit 210 is an information processing device constituted by a computer. The storage unit 220 is a storage device for storing information such as memory. For example, the storage unit 220 is a memory including multiple banks. The first communication unit 230 is a communication device for transmitting information to and receiving information from the first control devices 100 via the first communication network CN1. The second communication unit 240 is a communication device for transmitting information to and receiving information from another device (for example, the third control device 300, the external device ED, another second control device 200, and the first control devices 100 connected to the another second control device 200) via the second communication network CN2.

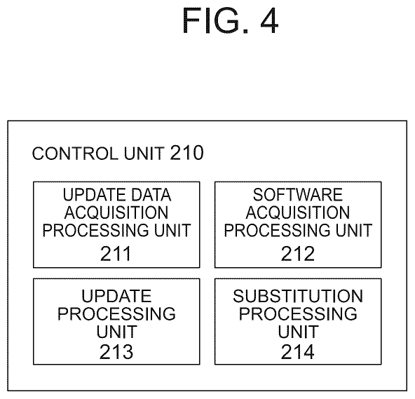

FIG. 4 is a diagram illustrating the control unit 210 of the second control device 200. The control unit 210 includes an update data acquisition processing unit 211, a software acquisition processing unit 212, and an update processing unit 213.

If another device (for example, the third control device 300 and the external device ED) has update data for the software of the first control device 100 connected to the second control device 200, the update data acquisition processing unit 211 uses communication performed by the second communication unit 240 to acquire the update data and stores the acquired update data to the storage unit 220. In a case where the update data is to be acquired from the external device ED, the update data acquisition processing unit 211 acquires the update data from the external device ED via the third communication network CN3, the third control device 300, and the second communication network CN2.

If the update data acquisition processing unit 211 has acquired the update data, the software acquisition processing unit 212 uses communication performed by the first communication unit 230 to acquire the software of the first control device 100 corresponding to the update data from the first control device 100 and store the acquired software to the storage unit 220.

When the update data for the software of the first control device 100 has been stored in the storage unit 220, the update processing unit 213 uses the update data to update the software of the first control device 100 corresponding to the update data.

When the processing of the update of the software of the first control device 100 is finished, the update processing unit 213 determines whether the software of the first control device 100 has been successfully updated. For example, if the updated software has been successfully activated on the first control device 100, the update processing unit 213 determines that the software of the first control device 100 has been successfully updated, and if the updated software has not been successfully activated on the first control device 100, the update processing unit 213 determines that the software of the first control device 100 has not been successfully updated.

Then, when the software of the first control device 100 has been successfully updated, the update processing unit 213 erases the software of the first control device 100 and the update data stored in the storage unit 220.

When the software of the first control device 100 has not been successfully updated, the update processing unit 213 installs the software of the first control device 100 stored in the storage unit 220 to the first control device 100. After the install of the first control device 100, the update processing unit 213 erases the software of the first control device 100 and the update data stored in the storage unit 220 if the first control device 100 is successfully installed, and installs the software of the first control device 100 stored in the storage unit 220 to the first control device 100 all over again if the first control device 100 is not successfully installed.

In this case, for example, if the installed software has been successfully activated on the first control device 100, the update processing unit 213 determines that the software of the first control device 100 has been successfully installed, and if the installed software has not been successfully activated on the first control device 100, the update processing unit 213 determines that the software of the first control device 100 has not been successfully installed.

As described above, in the present embodiment, before the update of the first control device 100 starts, the unupdated software of the first control device 100 is stored to the storage unit 220 of the second control device 200. Therefore, in the present embodiment, in a case where the first control device 100 has not been successfully updated, the software of the first control device 100 can be restored to the pre-update state by using the software of the first control device 100 stored in the storage unit 220 of the second control device 200. In particular, in the present embodiment, even if the software of the first control device 100 is updated in the single bank configuration, i.e., even if the unupdated software of the first control device 100 cannot be stored to the storage unit 120 of the first control device 100 during update of the software of the first control device 100, the software of the first control device 100 can be restored to the pre-update state by using the software of the first control device 100 stored in the storage unit 220 of the second control device 200 when the first control device 100 has not been successfully updated.

Furthermore, as illustrated in FIG. 4, the control unit 210 of the second control device 200 according to the present embodiment includes a substitution processing unit 214. While the update processing unit 213 is updating the software of the first control device 100, the substitution processing unit 214 substitutes for the function of the first control device 100 by using the software of the first control device stored in the storage unit 220. In this case, the update processing unit 213 may start update of the software of the first control device 100 after the substitution processing unit 214 starts substituting for the function of the first control device 100.

The substitution processing unit 214 controls the load L connected to the first control device 100 on behalf of the control unit 110 of the first control device 100. In this case, for example, the substitution processing unit 214 uses communication performed by the first communication unit 230 to acquire information received by the input unit 140 of the first control device 100 (for example, information from the input device ID and the sensor SE connected to the input unit 140) and output information based on the acquired information to the load L from the output unit 150 of the first control device 100, thus controlling the load L. Furthermore, the substitution processing unit 214 outputs information based on information received by the first communication unit 230 and the second communication unit 240 (for example, information transmitted from another first control device, another second control device 200, the third control device, and the external device ED) to the load L from the output unit 150, thus controlling the load L.

Therefore, in the present embodiment, even if the software of the first control device 100 is updated in the single bank configuration, the function of the first control device 100 can be executed during update of the software of the first control device 100. Specifically, in the present embodiment, even if the software of the first control device 100 is updated in the single bank configuration, i.e., even if the unupdated software of the first control device 100 cannot be stored in the storage unit 120 of the first control device 100 during update of the software of the first control device 100, the software of the first control device 100 can be updated without interrupting the function of the first control device 100.

In this case, if the software of the first control device 100 has been successfully updated after the processing of updating the software of the first control device 100 is finished, the substitution processing unit 214 terminates the substitution for the function of the first control device 100. Conversely, if the software of the first control device 100 has not been successfully updated after the processing of updating the software of the first control device 100 is finished, the substitution processing unit 214 substitutes for the function of the first control device 100 even while the update processing unit 213 is installing the software stored in the storage unit 220 to the first control device 100. Then, after the software stored in the storage unit 220 has been successfully installed to the first control device 100, the substitution processing unit 214 terminates the substitution for the function of the first control device 100.

Then, after the substitution for the function of the first control device 100 by the substitution processing unit 214 is finished, the update processing unit 213 erases the software of the first control device 100 stored in the storage unit 220.

In a case where the control system is a zone-based control system for the vehicle M, if the software of the first control device 100 is stored to the storage unit 220 by the software acquisition processing unit 212 when the ignition power of the vehicle M is in an OFF state, the substitution processing unit 214 may start the substitution for the function of the first control device 100 after the ignition power of the vehicle M is turned ON, instead of immediately starting the substitution for the function of the first control device 100. In other words, if the software of the first control device 100 is stored to the storage unit 220 by the software acquisition processing unit 212, the substitution processing unit 214 may check whether the ignition power of the vehicle M is in an ON state. Then, the substitution processing unit 214 may be configured to not start the substitution for the function of the first control device 100 when the ignition power of the vehicle M is in an OFF state, and to start the substitution for the function of the first control device 100 when the ignition power of the vehicle M is in an ON state.

### <Processing Operation Executed by the Second Control Device 200>

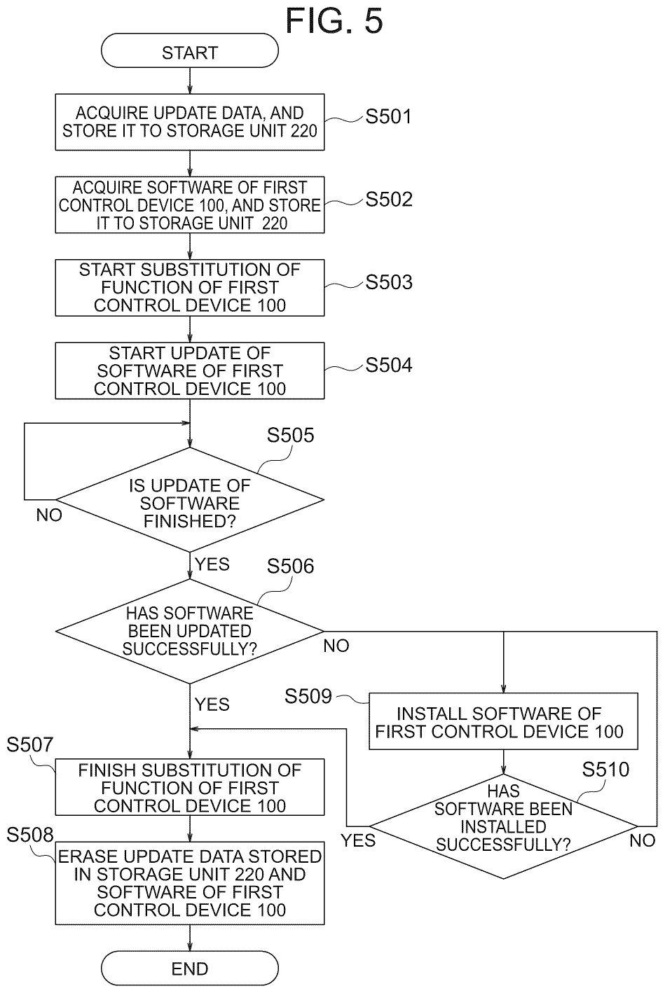

FIG. 5 is a diagram illustrating an example of a processing operation executed in the control unit 210 of the second control device 200 when another device has update data for the software of the first control device 100.

The update data acquisition processing unit 211 uses communication performed by the second communication unit 240 to acquire the update date from the another device, and stored the acquired update data to the storage unit 220 (step S501).

When the update data acquisition processing unit 211 has acquired the update data, the software acquisition processing unit 212 uses communication performed by the first communication unit 230 to acquire the software of the first control device 100 corresponding to the update data from the first control device 100, and stores the acquired software to the storage unit 220 (step S502).

If the software of the first control device 100 is stored to the storage unit 220 by the software acquisition processing unit 212, the substitution processing unit 214 uses the software of the first control device 100 stored in the storage unit 220 to start the substitution for the function of the first control device 100 (step S503).

When the substitution processing unit 214 starts the substitution for the function of the first control device 100, the update processing unit 213 uses the update data stored in the storage unit 220 to start updating the software of the first control device 100 (step S504).

When the update of the software of the first control device 100 is finished (step S505, YES), the update processing unit 213 determines whether the software of the first control device 100 has been successfully updated (step S506).

In a case where the software of the first control device 100 has been successfully updated (step S506, YES), the substitution processing unit 214 terminates the substitution for the function of the first control device 100 (step S507), and the update processing unit 213 erases the software of the first control device 100 and the update data stored in the storage unit 220 (step S508).

In a case where the software of the first control device 100 has not been successfully updated (step S506, NO), the update processing unit 213 installs the software of the first control device 100 stored in the storage unit 220 to the first control device 100 (step S509). When the software of the first control device 100 has been successfully installed (step S510, YES), the substitution processing unit 214 terminates the substitution for the function of the first control device 100 (step S507), and the update processing unit 213 erases the software of the first control device 100 and the update data stored in the storage unit 220 (step S508). When the software of the first control device 100 has not been successfully installed (step S510, NO), the update processing unit 213 installs the software of the first control device 100 stored in the storage unit 220 to the first control device 100 all over gain (step S509).

In a case where the control system is a zone-based control system for the vehicle M, if it is discovered that another device has update software for the first control device 100 when the ignition power of the vehicle M is in an OFF state, the control unit 210 may be configured to execute only the processing in step 501 and step 502 while the ignition power of the vehicle M is in an OFF state, and execute the processing from step S503 to step S508 after the ignition power of the vehicle M is turned ON. In other words, in this case, in step S503 explained above, when the ignition power of the vehicle M is turned ON, the substitution processing unit 214 may use the software of the first control device 100 stored in the storage unit 220 to start the substitution for the function of the first control device 100.

The present invention has been described above with reference to the preferred embodiment of the present invention. Although the present invention has been described herein with reference to specific examples, various modifications and changes can be made to these examples without departing from the spirit and scope of the invention as set forth in the claims.

### LIST OF REFERENCE SIGNS

100 first control device
110 control unit
120 storage unit
130 communication unit
140 input unit
150 output unit
200 second control device
210 control unit
211 update data acquisition processing unit
212 software acquisition processing unit
213 update processing unit
214 substitution processing unit
300 third control device

What is claimed is:

1. A second control device comprising a storage unit and a control unit, and connected to a first control device via a first communication network,
the control unit includes:
an update processing unit configured to update software of the first control device; and
a software acquisition processing unit configured to acquire the software of the first control device from the first control device before the update of the software of the first control device starts, and store the acquired software to the storage unit.

2. The second control device according to claim 1, wherein the control unit includes a substitution processing unit that uses the software of the first control device stored in the storage unit to substitute for a function of the first control device while the software of the first control device is updated.

3. The second control device according to claim 1, wherein the control unit further includes an update data acquisition processing unit configured to, when another device has update data for the software of the first control device, acquire the update data and stores the acquired update data to the storage unit,
when the update data acquisition processing unit acquires the update data, the software acquisition processing unit acquires the software of the first control device from the first control device, and stores the acquired software to the storage unit,
when the software of the first control device is stored to the storage unit, the update processing unit uses the update data acquired by the update data acquisition processing unit to start updating the software of the first control device.

4. The second control device according to claim 1, wherein when the software of the first control device has not been successfully updated, the update processing unit installs the software stored in the storage unit to the first control device.

5. The second control device according to claim 2, wherein the control unit further includes an update data acquisition processing unit configured to, when another device has update data for the software of the first control device, acquire the update data,
when the update data acquisition processing unit acquires the update data, the software acquisition processing unit acquires the software of the first control device from the first control device, and stores the acquired software to the storage unit,
when the software of the first control device is stored to the storage unit, the substitution processing unit uses the software of the first control device stored in the storage unit to substitute for the function of the first control device, and
when the substitution processing unit starts substitution for the function of the first control device, the update processing unit uses the update data acquired by the update data acquisition processing unit to start updating the software of the first control device.

6. The second control device according to claim 1, wherein the first control device and the second control device are provided in a vehicle, and
an external device is provided outside the vehicle.

7. A control system comprising:
a plurality of first control devices; and
a second control device according to claim 1 connected to the plurality of first control devices via the first communication network.

8. A control system comprising:
a plurality of second control devices according to claim 1; and
a third control device connected to the plurality of second control devices via a second communication network.

9. A control method executed by a second control device connected to a first control device via a first communication network, the control method comprising:
an update processing step of updating software of the first control device;
a software acquisition processing step of acquiring software of the first control device from the first control device before the update of the software of the first control device starts, and storing the acquired software to the storage unit of the second control device.

10. A control program for causing a computer to execute the control method of claim 9.
